(19) United States
(12) Patent Application Publication
(10) Pub. No.: US 2013/0088486 A1
(43) Pub. Date: Apr. 11, 2013

(54) 3D IMAGE DISPLAY APPARATUS AND 3D IMAGE DISPLAY METHOD PERFORMED IN THE SAME

(71) Applicants: Ki Hyuk YOON, Seoul (KR); Sung Kyu KIM, Seoul (KR); Seon Kyu YOON, Jeju-Si (KR)

(72) Inventors: Ki Hyuk YOON, Seoul (KR); Sung Kyu KIM, Seoul (KR); Seon Kyu YOON, Jeju-Si (KR)

(21) Appl. No.: 13/547,566

(22) Filed: Jul. 12, 2012

(30) Foreign Application Priority Data
Oct. 6, 2011 (KR) 10-2011-0101771

(51) Int. Cl. G06T 15/00

(52) U.S. Cl. 345/419

(57) ABSTRACT

Provided are a three-dimensional (3D) image display apparatus and a 3D image display method performed in the same. The 3D image display apparatus using a line light source includes a light source substrate formed by disposing a plurality of point light sources on a plane, a lenticular lens sheet spaced a predetermined interval from the light source substrate, a control unit configured to control the plurality of point light sources of the light source substrate to form line light sources spaced a predetermined interval from the lenticular lens sheet, and a display panel spaced a predetermined interval from the line light sources formed by the control unit.

### CROSS-REFERENCE TO RELATED APPLICATION

This application claims priority to and the benefit of Korean Patent Application No. 2011-0101771, filed on Oct. 6, 2011, the disclosure of which is incorporated herein by reference in its entirety.

### BACKGROUND

1. Field of the Invention

The present invention relates to a three-dimensional (3D) image display apparatus, and more particularly, to an autostereoscopic 3D image display apparatus using a line light source controlling an ON/OFF operation of a plurality of point light sources to generate a plurality of line light sources spaced apart from each other at predetermined intervals using the plurality of point light sources and a lenticular lens sheet such that a viewer can see a 3D image without special 3D glasses.

2. Discussion of Related Art

In recent times, users' need for a display apparatus capable of implementing a three-dimensional (3D) image showing an actual 3D effect, which cannot be implemented in a conventional two-dimensional (2D) image, has increased, and thus, display apparatuses capable of implementing a 3D image have been developed.

In general, the 3D image is provided by a stereo vision principle through two eyes, and thus, a display apparatus capable of showing a 3D image using binocular disparity caused by disparity between the two eyes, i.e., presence of the two eyes spaced apart from each other by about 65 mm, has been proposed.

Specifically, in implementation of a 3D image, left and right eyes watching the display apparatus see different two 2D images. When the two images are transmitted to the brain through retinas, the brain precisely combines the images to feel depth and reality of the original 3D image, which is generally referred to as stereography.

For example, techniques proposed to display a 3D image through an apparatus having a 2D image display screen such as a liquid crystal display include a special glasses type 3D display, an autostereoscopic 3D display, and a holographic display.

A conventional autostereoscopic 3D image display apparatus includes a disparity separation means disposed in front of the conventional 2D image display apparatus to transmit images having different disparities to the viewer's left and right eyes, providing a 3D image so that an actual 3D image is displayed to the viewer.

FIGS. 1 and 2 are a perspective view and a side view for explaining the conventional autostereoscopic 3D image display apparatus, showing a structure of a backlight in which an array of line light sources is formed to be used in the autostereoscopic 3D image display apparatus.

Referring to FIGS. 1 and 2, the backlight implementing the line light sources includes a plurality of grooves regularly formed in an upper surface of a light guide such that light emitted from a light source formed at a side surface of the light guide passes through the light guide to be totally reflected, with the total reflection conditions not being applied at positions of the grooves, and thus, the light is emitted from the positions of the grooves to make the line light sources according to the shapes of the grooves.

FIG. 3 is a concept view for explaining a two-viewpoint 3D image implementation principle by a backlight used in the conventional autostereoscopic 3D image display apparatus, and FIG. 4 shows graphs representing examples of variation in viewing zones when a viewer moves forward and backward from an optimum viewing distance of the conventional autostereoscopic 3D image display apparatus, illustrating a 3D image viewing principle using line light sources and viewing zones separation.

That is, when the autostereoscopic 3D image display apparatus is implemented using the line light sources, various advantages are provided. One of these is that a 3D image is embodied without use of a parallax barrier or a lenticular lens, which are disparity separation means used for viewing zone formation in a general autostereoscopic 3D image display apparatus, and another is that a problem of reduction, in optical efficiency caused by a region blocked at the disparity separation means is solved. In particular, when a 3D image is embodied using the parallax barrier, the optical efficiency is largely reduced as the number of viewpoints of a multi-viewpoint image is increased.

However, while an advantage of not using the disparity separation means is maintained, problems of the conventional autostereoscopic 3D image display apparatus remain.

First, there is reduction in picture quality of a 3D image for a viewer moving forward and backward at the optimal viewing distance (OVD) from the display. This is because characteristics of the viewing zone deteriorate as the viewing zone deviates from the OVD.

For example, reviewing a simulation result of the autostereoscopic 3D image display apparatus using the line light sources of FIG. 4, it will be appreciated that characteristics of the viewing zone at the OVD of 1000 mm have a large area in which brightness is uniformly ensured (see FIG. 4A), the uniform brightness region in the viewing zone is reduced as difference between the viewing distance and the OVD increases, and crosstalk, which is an overlapping phenomenon between adjacent viewing zones, is increased.

In addition, it will be appreciated that a region in which a uniform viewing zone in one viewing zone almost disappears is within a range of about 1030 mm, which is increased by about 3% from the OVD, and a distance from which a 3D image can be viewed is extremely limited. While the illustrated simulation represents only the case in which the viewing distance is increased, the same phenomenon is shown when the viewing distance is reduced from the OVD.

Meanwhile, reviewing simulation conditions of FIG. 4, a pixel size P_{d} is 0.45 mm, an OVD d is 1000 mm, a viewing zone size a is 65 mm, a number of viewpoints is two, an interval c between a line light source and a display is 6.9713 mm, an interval P₁ between the line light sources is 0.906 mm, and a line width of the line light source is 0.15 mm.

Second, when the viewer moves from the optimal position in a horizontal direction of the display and views the display, picture quality of a 3D image may be degraded or a reversed 3D image may be viewed.

It is difficult to solve these problems through the conventional autostereoscopic 3D image display apparatus using fixed line light sources.

### SUMMARY OF THE INVENTION

The present invention is directed to a three-dimensional (3D) image display apparatus controlling an ON/OFF operation of a plurality of point light sources to generate a plurality of line light sources spaced apart from each other at predetermined intervals using the plurality of point light sources and a lenticular lens sheet, so that a viewer can see a 3D image without special 3D glasses.

The present invention is also directed to a 3D image display apparatus using line light sources and controlling an ON/OFF operation of the line light sources according to a position of a viewer even when the position of the viewer from a display panel varies, so that the viewer can move and see an optimal 3D image without specific glasses.

The present invention is also directed to a 3D image display apparatus including a separate location tracking system to enable a viewer who views a 3D image from a display panel to view a smooth 3D image even when the viewer moves, and a 3D image display method performed in the same.

According to an aspect of the present invention, there is provided a 3D image display apparatus including: a light source substrate formed by disposing a plurality of point light sources on a plane; a lenticular lens sheet spaced a predetermined interval from the light source substrate; a control unit configured to control the plurality of point light sources of the light source substrate to form line light sources spaced a predetermined interval from the lenticular lens sheet; and a display panel spaced a predetermined interval from the line light sources formed by the control unit.

Here, the plurality of point light source may be formed of optical fibers. Alternatively, the plurality of point light sources may be formed of liquid crystal displays (LCDs) or light emitting diodes (LEDs).

Preferably, one arbitrary set of point light sources disposed in parallel in a longitudinal direction of the lenticular lens sheet and an adjacent set of point light sources spaced a first distance from the one set of point light sources, among the plurality of point light sources, may be turned ON by the control unit. Here, the first distance may correspond to a pitch of the lenticular lens sheet.

Preferably, the optical fibers forming the point light sources may be constituted of two or more kinds of point light source sets having different distances in a depth direction of the lenticular lens sheets spaced apart from each other. In addition, the LCDs or LEDs may be formed of stack-type panels.

Preferably, the 3D image display apparatus may further include a location tracking system for the viewer, wherein the control unit receives information on a position of the viewer measured by the location tracking system and adjusts positions or the one arbitrary set of point light sources and positions of the adjacent set of point light sources such that a 3D image can be viewed without distortion even when the viewing position of the viewer varies. In addition, the location tracking system may be a location tracking system based on pupil tracking or face tracking of the viewer.

Preferably, a formation direction of a lenticular shape of the lenticular lens sheet may be inclined from a vertical direction at a certain angle.

Preferably, as a distance between the position of the viewer and the 3D image display apparatus varies, one set of point light sources having a first depth direction among the point light sources having different distances in the depth direction and the adjacent set of point light sources in the first depth direction spaced a first distance therefrom may be turned ON. Here, the first distance may correspond to a pitch of the lenticular lens sheet.

According to another aspect of the present invention, there is provided a 3D image display method performed in a 3D image display apparatus including a light source substrate formed by disposing a plurality of point light sources on a plane, a lenticular lens sheet spaced a predetermined interval from the light source substrate, a display panel spaced a predetermined interval from line light sources, and a location tracking system for a viewer, the method including: measuring a position of the viewer by the position tracking system; and turning ON one arbitrary set of point light sources disposed in parallel in a longitudinal direction of the lenticular lens sheet and an adjacent set of point light sources spaced a first distance from the one set of point light sources according to position information on the viewer to form line light sources spaced a predetermined interval from the lenticular lens sheet.

Here, when the viewer varies a viewing position from the display panel, positions of the one arbitrary set of point light sources and positions of the adjacent set of point light sources, which are turned ON, may be adjusted according to position information on the viewer such that a 3D image is viewed without distortion even when the viewing position of the viewer varies. In particular, when a distance between the viewer and the display panel varies, one set of point light sources having a first depth direction among the point light sources having different distances in the depth direction and the adjacent set of point light sources in the first depth direction spaced a first distance therefrom may be turned ON according to position information on the viewer so that the 3D image is viewed without distortion even when the viewing position of the viewer varies. Here, the first distance may correspond to a pitch of the lenticular lens sheet.

Preferably, the location tracking system may be a location tracking system based on pupil tracking or face tracking of the viewer.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIGS. 1 and 2 are a perspective view and a side view for explaining a conventional glassesless type three-dimensional (3D) image display apparatus;

FIG. 3 is a concept view for explaining a two-viewpoint 3D image implementation principle by a backlight used in the conventional autostereoscopic 3D image display apparatus;

FIG. 4 shows graphs representing examples of variation in viewing zone when a viewer moves forward and backward from an optimal display distance of the conventional autostereoscopic 3D image display apparatus;

FIG. 5 is a planar concept view for explaining a 3D image display apparatus using a line light source in accordance with a first exemplary embodiment of the present invention;

FIGS. 6 and 7 are concept views for explaining a generation principle of a line light source in the 3D image display apparatus using the line light source in accordance with the first exemplary embodiment of the present invention;

FIG. 8 is a concept view for explaining line light sources generated in the 3D image display apparatus using the line light sources in accordance with the first exemplary embodiment of the present invention and a variation principle of a position at which a horizontal viewing zone is formed using the same;

FIG. 9 is a planar concept view for explaining a 3D image display apparatus using a line light source in accordance with a second exemplary embodiment of the present invention;

FIGS. 10 and 11 are concept views for explaining a generation principle of a line light source in the 3D image display apparatus using the line light source in accordance with the second exemplary embodiment of the present invention, FIGS. 10B to 10D showing the line light sources of FIG. 10A respectively;

FIG. 12 is a concept view for explaining line light sources generated in the 3D image display apparatus using the line light sources in accordance with the second exemplary embodiment of the present invention and a variation principle of an optimal viewing position in a depth direction of the 3D image using the same;

FIG. 13 is a planar concept view for explaining a 3D image display apparatus using a line light source in accordance with a third exemplary embodiment of the present invention; and

FIG. 14 is a planar concept view for explaining a 3D image display apparatus using a line light source in accordance with a fourth exemplary embodiment of the present invention.

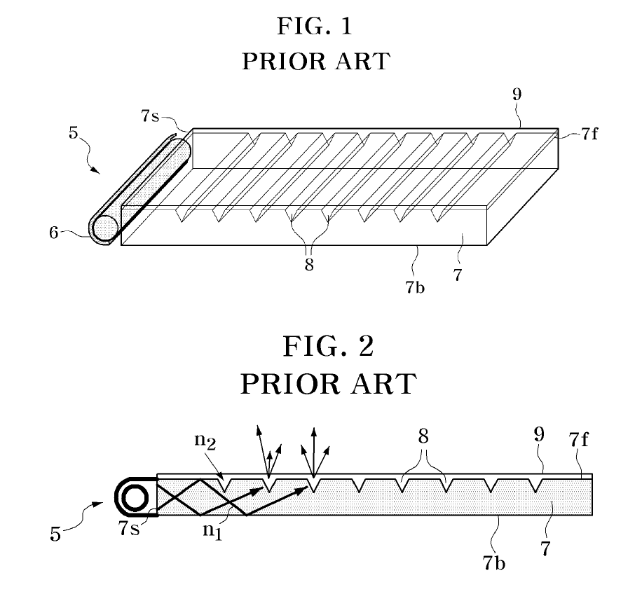

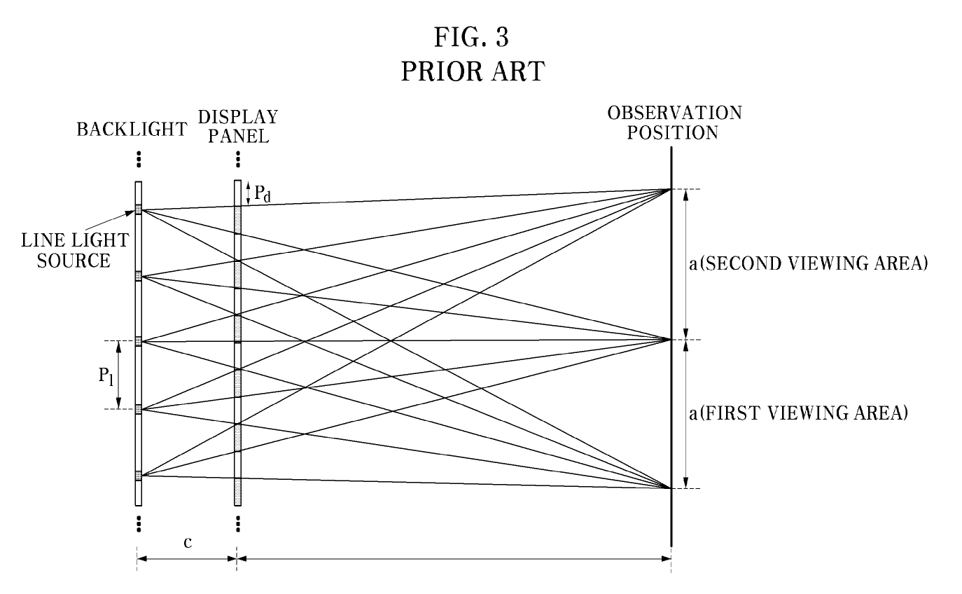

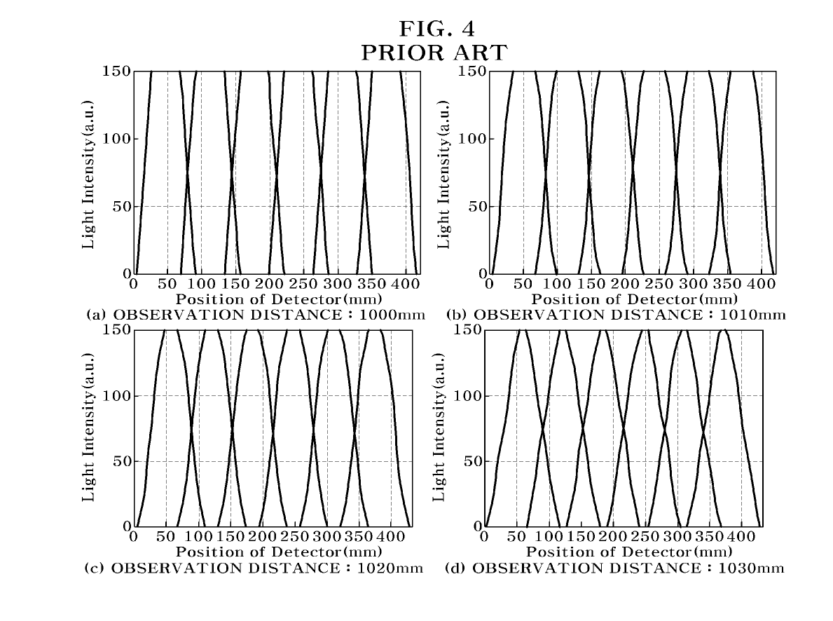

### DETAILED DESCRIPTION OF EXEMPLARY EMBODIMENTS

Exemplary embodiments of the present invention will be described in detail below with reference to the accompanying drawings. While the present invention is shown and described in connection with exemplary embodiments thereof, it will be apparent to those skilled in the art that various modifications can be made without departing from the spirit and scope of the invention.

### First Embodiment

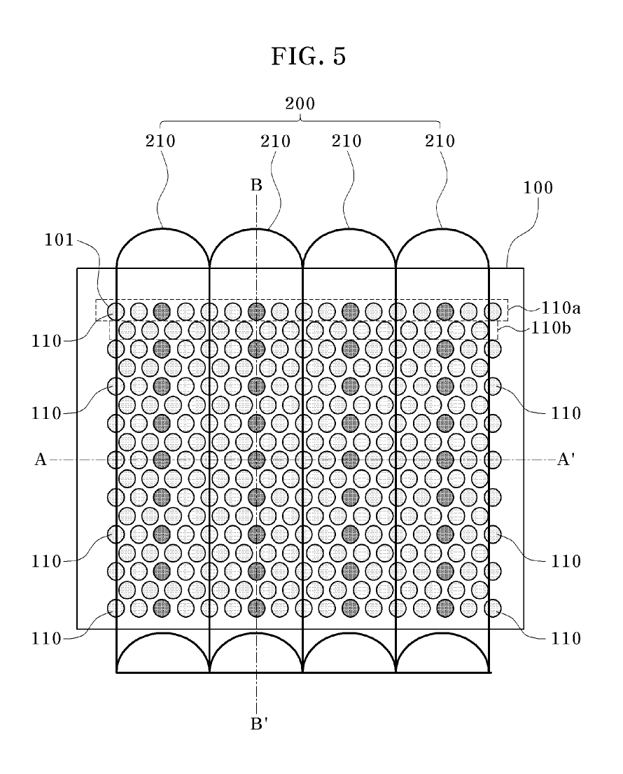

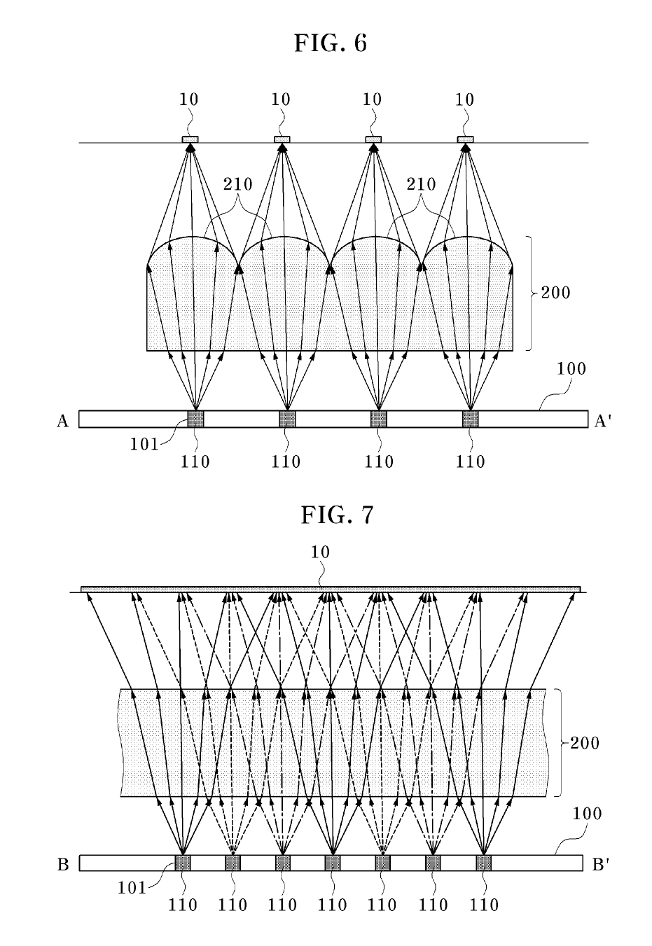

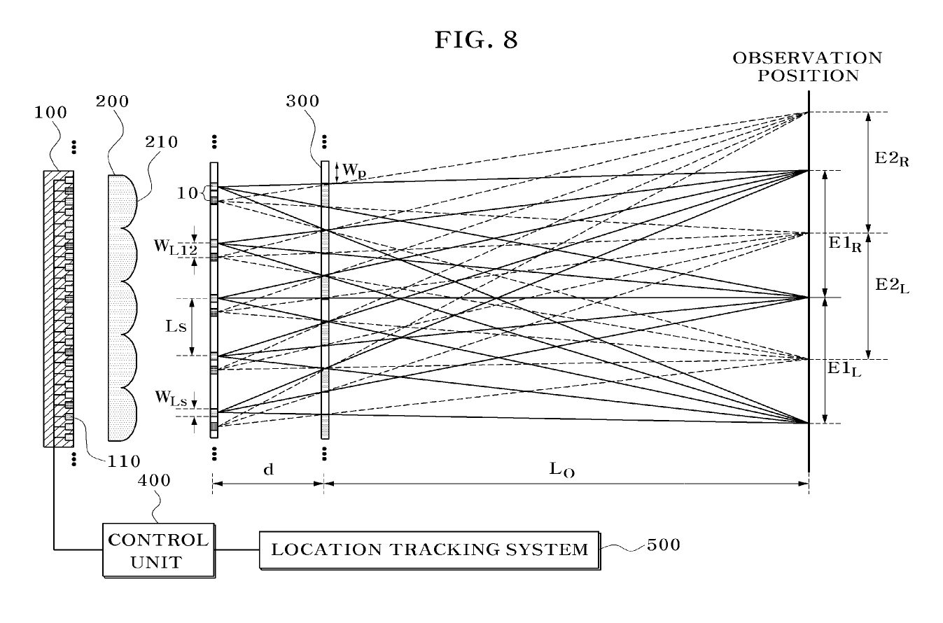

FIG. 5 is a planar concept view for explaining a three-dimensional (3D) image display apparatus using a line light source in accordance with a first exemplary embodiment of the present invention, FIGS. 6 and 7 are concept views for explaining a generation principle of a line light source in the 3D image display apparatus using the line light source in accordance with the first exemplary embodiment of the present invention, and FIG. 8 is a concept view for explaining line light sources generated in the 3D image display apparatus using the line light sources in accordance with the first exemplary embodiment of the present invention and a variation principle of a position at which a horizontal viewing zone is formed using the same.

Referring to FIGS. 5 to 8, the 3D image display apparatus using the line light source in accordance with the first exemplary embodiment of the present invention generally includes a light source substrate 100, a lenticular lens sheet 200, a display panel 300, a control unit 400, and so on.

Here, the light source substrate 100, which is a planar plate, is formed of a plastic material such as acryl, and formed by disposing a plurality of point light sources on a plane. For example, while a plurality of point light sources 110 may be uniformly formed on one surface as shown in FIG. 5, the present invention is not limited to this disposition method.

Here, specifically, a method of forming the plurality of point light sources 110 includes forming a plurality of holes 101 on the light source substrate 100 in a certain pattern, i.e., in an oblique pattern, fixing one ends of optical fibers (not shown) to the holes 101, respectively, and connecting light sources (not shown) to the other ends of the optical fibers fixed to the holes 101 to emit a predetermined amount of light to the optical fibers, which may be individually or simultaneously operated. Here, the light sources connected to the ends of the optical fibers according to line light sources to be formed may be operated by being turned ON.

In addition, the plurality of point light sources 110 may use a high resolution display such as a liquid crystal display (LCD) or light emitting diode (LED) panel as a point light source. Here, for example, each pixel may serve as a point light source. When a high resolution display is used as a point light source, selection of a point light source to be turned ON is facilitated.

Meanwhile, in one example of disposition of the point light sources 110 formed on the light source substrate 100, as shown in FIG. 5, when the light source substrate 100 is seen from a plan view, first point light source sets 110a, each having a plurality of the point light sources 110 disposed at predetermined intervals in a row (line A-A′) direction, may be disposed at predetermined intervals in a column (line B-B′) direction, and second point light source sets 110b having the same pattern as the first point light source sets 110a may be disposed between the first point light source sets 110a in the column (line B-B′) direction.

Here, centers of the point light sources 110 included in each second point light source set 110b may be disposed between centers of the point light sources 110 included in each first point light source set 110a, that is, the centers of the point light sources 110 may be disposed in a zigzag manner. Accordingly, a larger number of point light sources can be disposed in a limited space, and spatial utilization can be maximized.

Meanwhile, as shown in FIG. 5, when the centers of the plurality of point light sources 110 are connected to each other, while the centers may have a diamond-like mesh shape, the centers are not limited thereto but may have a polygonal mesh shape such as a rectangular, pentagonal or hexagonal shape. In addition, while the shape of the point light source is shown to be circular in FIG. 5, the shape is not limited thereto but may be quadrangular, rectangular, elliptical, or so on.

The lenticular lens sheet 200, which is an optical member configured to form at least one line light source with the plurality of point light sources 110, is disposed at a predetermined interval from the light source substrate. For example, as shown in FIG. 5, the one side surface (or an incident surface) is disposed a predetermined interval from the plurality of point light sources 110 formed at the light source substrate 100, and a plurality of cylindrical (cylinder-like) lenticular lens parts 210 may be formed at the other surface (or an emission surface) in an array pattern. Alternatively, the lenticular lens parts may be formed at the one side surface (or the incident surface).

A line light source 10 parallel to a longitudinal direction (i.e., a cylindrical direction (line B-B′)) of each cylindrical lenticular lens part 210 may be formed at a position spaced a predetermined interval from the lenticular lens sheet 200 (i.e., a position focused by concentrated light) by each cylindrical lenticular lens part 210 of the lenticular lens sheet 200.

The display panel 300 is disposed a predetermined interval from the line light source 10 formed by a lens effect of the cylindrical lenticular lens part 210, and serves to display a 3D image using the line light source 10. The display panel 300 may be implemented as a conventional display panel such as an LCD or LED panel.

The control unit 400 serves to control the plurality of point light sources of the light source substrate 100 to form line light sources spaced a predetermined interval from the lenticular lens sheet 200. That is, the point light sources 110 that are turned ON according to a control signal of the control unit 400 may form the line light source 10 parallel to the longitudinal direction of each cylindrical lenticular lens part 210 at a position spaced a predetermined interval from the other side surface of the lenticular lens sheet 200 by a lens effect of the cylindrical lenticular lens part 210.

Here, as shown in FIG. 5, the control unit 400 (see FIG. 8) may turn ON one arbitrary set of point light sources disposed parallel to the longitudinal direction of the lenticular lens sheet and an adjacent set of point light sources spaced a first distance therefrom, among the plurality of point light sources. Here, a column of the one arbitrary set of point light sources may or may not coincide with a lens axis of the lenticular lens sheet. In addition, the first distance, which corresponds to a pitch of the lenticular lens sheet, may be substantially the same as a distance of the pitch or may be slightly different from the distance of the pitch. In FIG. 5, in order to more clearly discriminate the point light sources 110 turned ON by the control unit 440, the point light sources 110 are represented in a thicker shade than the other point light sources 110. Meanwhile, the interval between the point light sources 110 parallel to the longitudinal direction of the cylindrical lenticular lens part 210 may be adjusted according to an angle of the light emitted from the point light sources.

Additionally, a separate location tracking system 500 may be further provided so that the viewer who views the 3D image displayed from the display panel 300 can view a smooth 3D image even when moving his/her face or eyes in a horizontal direction. The control unit 400 can receive information on a position of the viewer's face or eyes detected by the location tracking system 500 and adjust positions of the one arbitrary set of point light sources and positions of the adjacent set of point light sources, which are turned ON, such that the viewer can see the 3D image without distortion even when the viewer's viewing position varies. The location tracking system 500 may be a location tracking system based on pupil tracking or face tracking of the viewer.

A fundamental principle of forming the line light source 10 by the point light sources 110 formed on the one surface of the light source substrate 100 and the lenticular lens sheet 200 disposed over the point light sources and spaced apart therefrom in the 3D image display apparatus using the line light source as described above will be described in detail below with reference to FIGS. 5 to 7.

First, several arbitrary sets of point light sources 110 parallel to the longitudinal direction of the cylindrical lenticular lens part 210 installed at the lenticular lens sheet 200 are sequentially turned ON through the control unit 400. Here, a spaced distance of the point light sources 110 turned ON in line in an array direction (direction of line A-A′) of the cylindrical lenticular lens part 210 may correspond to a pitch of the cylindrical lens part 210.

As shown in FIG. 6, the line light source 10 is imaged at a certain position after passing through the lenticular lens sheet 200 from the point light sources 110 formed on line A-A′ by the lens effect of the upper lenticular lens sheet 200 in a cross-sectional direction of line A-A′.

On the other hand, as shown in FIG. 7, the lights emitted from one line of point light sources 110 turned ON by a refraction effect at a vertical interface surface of the lenticular lens sheet 200 without the lens effect in a cross-sectional direction of line B-B′ as shown in FIG. 7 overlap each other to obtain continuous optical distribution at a certain distance from the lenticular lens sheet 200. Eventually, the line light sources 10 disposed in the direction of line B-B′ are formed.

In addition, the spaced interval between the point light sources 110 of FIG. 7 may be smaller than a maximum spaced distance in consideration of optical uniformity of the line light source at a position where the line light source 10 is formed. The interval needs to be determined according to angular distribution of the light emitted from the point light sources 110. For example, when an angle of the light emitted from the corresponding point light sources 110 is small, the spaced interval of the point light sources 110 on line B-B′ is reduced, and when the angle is large, the spaced interval is increased.

Meanwhile, as shown in FIG. 8, according to a fundamental principle of a method of varying a viewing zone forming position parallel to the display panel, the viewing zone forming position at the optimal viewing position varies according to the position of the line light source in the 3D image display apparatus using the line light source. As the set of point light sources turned ON in order to use this principle varies, the position of the line light source 10 formed after the lenticular lens sheet 200 can be varied. While FIG. 8 shows an embodiment of a two-viewpoint 3D image, the interval between the line light sources of a multi-viewpoint (3 or more viewpoints) 3D image may be adjusted and applied.

Variation in the viewing zone forming position in a parallel direction may be performed according to selection of point light sources, which will be turned ON according to feedback of the location tracking system, such that the viewer who views the 3D image from the display panel 300 can view a continuous smooth 3D image even when moving his/her position in a direction parallel to the display panel.

In addition, while not shown, the above-mentioned principle may be reflected to position movement in a vertical direction. When a vertical lenticular lens is used, since movement of the viewing zone is unnecessary to position movement in the vertical direction only, it is not necessary to vary the point light source set. However, when a slant lenticular lens is used, even if the viewer moves in a vertical direction, variation of the point light source set which is turned ON may be necessary.

### Second Embodiment

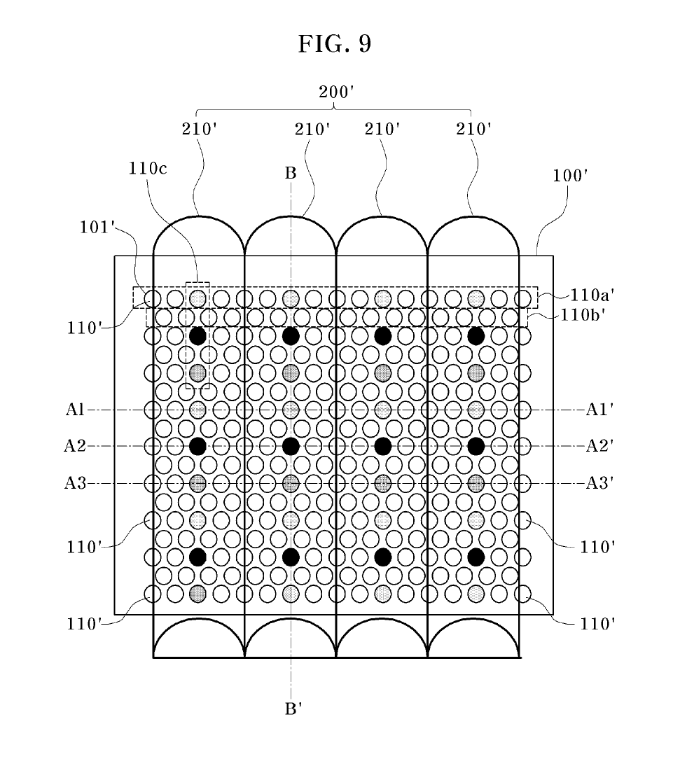

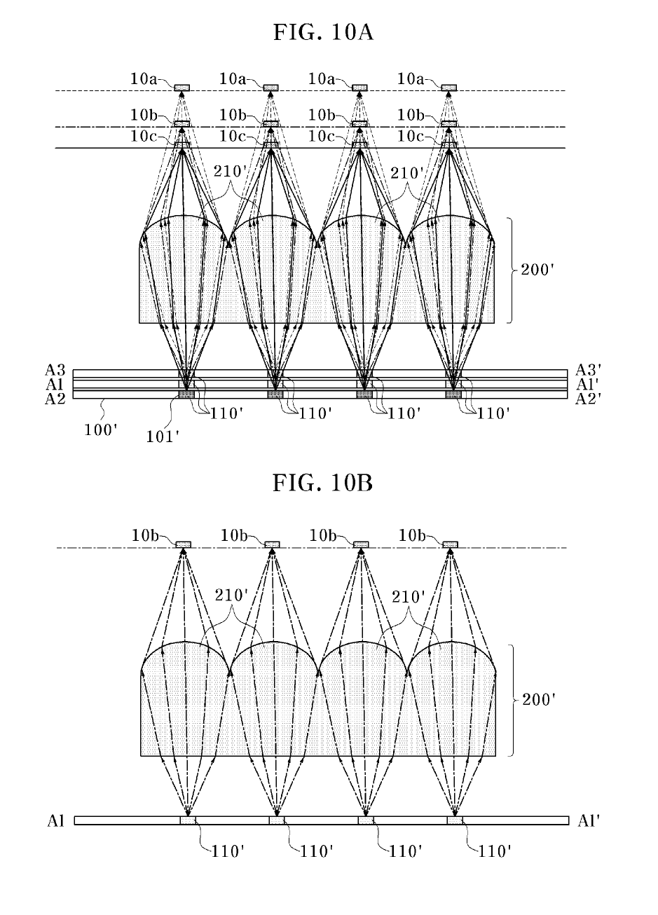

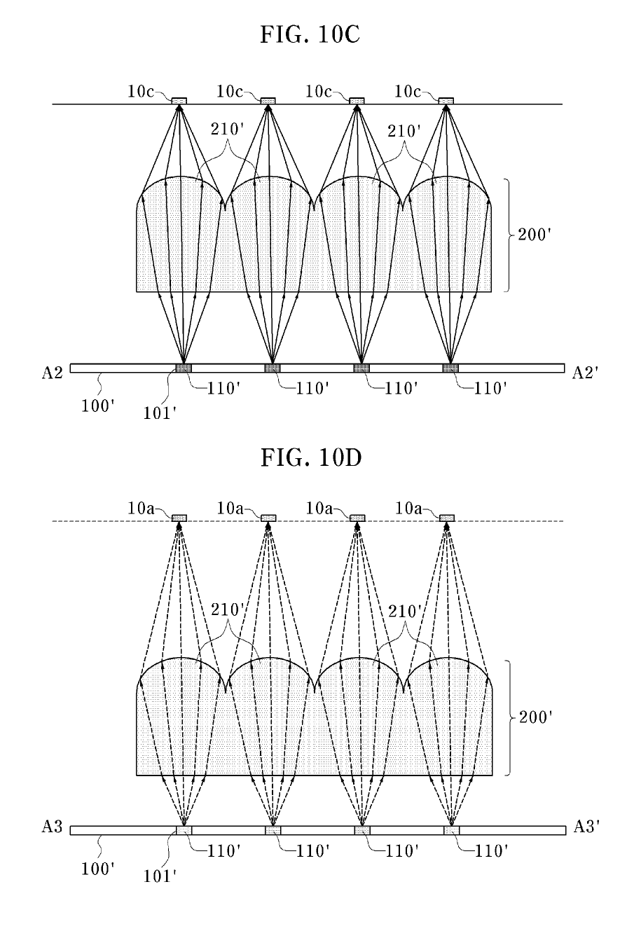

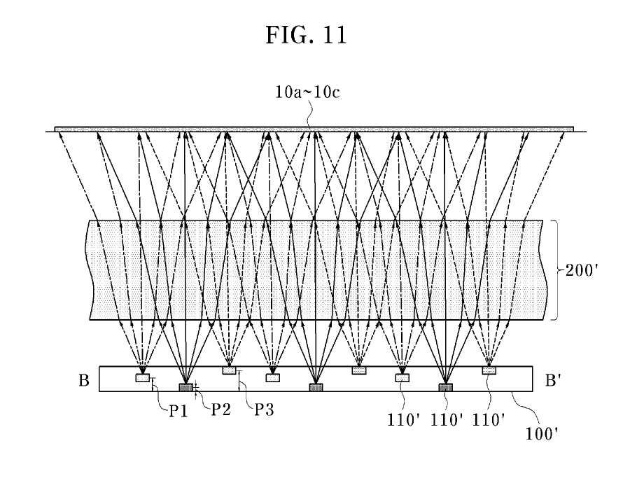

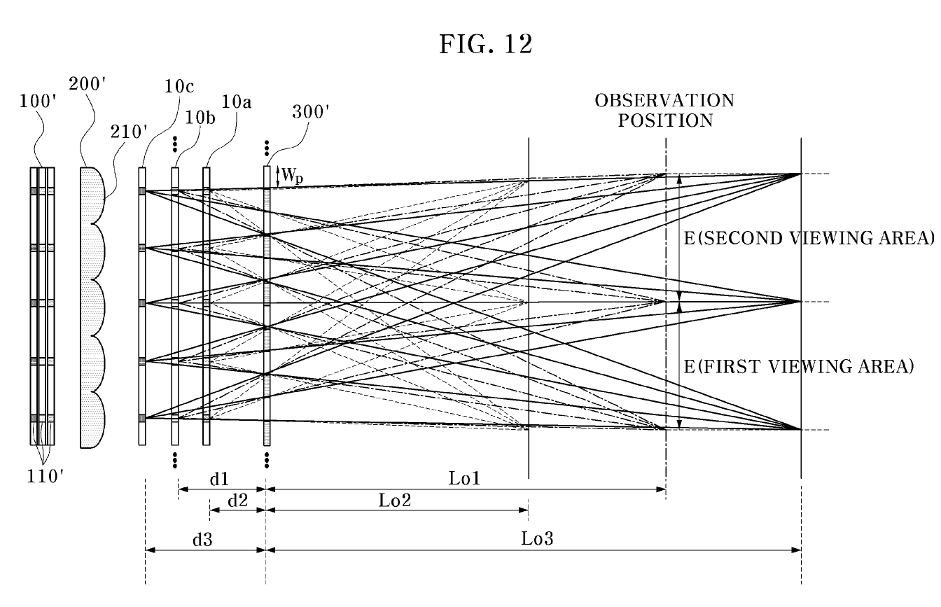

FIG. 9 is a planar concept view for explaining a 3D image display apparatus using a line light source in accordance with a second exemplary embodiment of the present invention, FIGS. 10 and 11 are concept views for explaining a generation principle of a line light source in the 3D image display apparatus using the line light source in accordance with the second exemplary embodiment of the present invention, FIGS. 10B to 10D showing the line light sources of FIG. 10A respectively, and FIG. 12 is a concept view for explaining line light sources generated in the 3D image display apparatus using the line light sources in accordance with the second exemplary embodiment of the present invention and a variation principle of an optimal viewing position in a depth direction of the 3D image using the same.

Referring to FIGS. 9 to 12, the 3D image display apparatus using the line light source in accordance with the second exemplary embodiment of the present invention generally includes a light source substrate 100′, a lenticular lens sheet 200′, a display panel 300′, a control unit 400′, and so on.

Here, since the lenticular lens sheet 200′ and the display panel 300′ are the same as the lenticular lens sheet 200 and the display panel 300 applied to the first embodiment of the present invention, detailed description thereof will not be repeated.

In addition, the light source substrate 100′, which is a planar plate, is formed of a plastic material such as acryl, and formed by disposing a plurality of point light sources on a plane. For example, as shown in FIG. 9, while a plurality of point light sources 110′ may be uniformly formed on one side surface thereof, the present invention is not limited to such a disposition.

Here, specifically describing a method of forming the plurality of point light sources 110′, a plurality of holes 101′ are uniformly formed on the light source substrate 100′ in a certain pattern, i.e., in an oblique pattern, one ends of optical fibers (not shown) are fixed to the holes 101′ respectively, and then, light sources (not shown) configured to emit a predetermined amount of light to the optical fibers, which are to be individually or simultaneously operated, are connected to the other ends of the optical fibers fixed to the holes 101′. Here, the light sources connected to the ends of the optical fibers may be turned ON/OFF according to line light sources to be formed. Meanwhile, the optical fibers configured to form point light sources in the embodiment may be constituted of at least two kinds of point light source sets having different distances in a depth direction from the lenticular lens sheet spaced apart therefrom.

The plurality of point light sources 110′ or the light source substrate 100′ including them may constitute, for example, a stack-type LCD or LED panel.

For example, as shown in FIG. 9, when the disposition of the point light sources 110′ formed on the light source substrate 100′ is seen from a plan view, first point light source sets 110a′, each including a plurality of the point light sources 110′ disposed at predetermined intervals in row (line A1-A1′, line A2-A2′ and line A3-A3′) directions, may be disposed at predetermined intervals in a column (line B-B′) direction, and second point light source sets 110b′ having the same shape as the first point light source sets 110a′ may be disposed between the first point light source sets 110a′ in the column (line B-B′) direction.

Here, centers of the point light sources 110′ included in each second point light source set 110b′ may be disposed between centers of the point light sources 110′ included in each first point light source 110a′, that is, the centers of the point light sources 110′ may be disposed in a zigzag manner. Accordingly, a larger number of point light sources can be disposed in a limited space, and spatial utilization can be maximized.

Meanwhile, as shown in FIG. 9, when the centers of the plurality of point light sources 110′ are connected to each other, while the centers may have a diamond-like mesh shape, the centers are not limited thereto but may have a polygonal mesh shape such as a rectangular, pentagonal or hexagonal shape. In addition, while the shape of the point light source is shown to be circular as in FIG. 9, the shape is not limited thereto but may be quadrangular, rectangular, elliptical, or so on.

In particular, as shown in FIGS. 9 and 10, for example, the plurality of point light sources 110′ formed parallel to the longitudinal direction of the cylindrical lenticular lens part 210′ may be arranged such that at least one third point light source set 110c, in which at least two point light sources having different depths are formed at one side surface of the light source substrate 100′, is disposed a predetermined interval from each other.

Additionally, at least one point light source 110′ may be further formed to the same depth as the corresponding point light source 110′ adjacent to each point light source 110′ between the point sources 110′ having different depths in the third point light source set 110c.

That is, in order to constitute line light source sets 10a to 10c having different positions in a depth direction thereof, the point light sources 110′ formed on the light source substrate 100′ are configured to have different positions in the depth direction. For example, as shown in FIG. 11, the point light sources 110′ are disposed to have the same positions (position P1) in the depth direction of the point light sources 110′ included in two rows, and different positions (positions P2 and P3) in the depth direction of the other point light sources 110′ in two adjacent rows, such that three positions in the depth direction can be arranged in six rows.

Meanwhile, the number of different positions in the depth direction can be adjusted to be larger, and the number of rows of the point light sources having a position in the depth direction of the point light source having the same height as the adjacent point light source can be adjusted by one row or more. FIG. 9 shows only the point light sources 110′ disposed at a center of the cylindrical lenticular lens part 210′ and on a straight line in a longitudinal direction of the lens in different shadows according to positions in the depth direction.

In addition, the control unit 400′ may select and control arbitrary point light sources 110′ formed at any one depth of the point light sources 110′ disposed parallel to the longitudinal direction of the cylindrical lenticular lens part 210′ and formed at different depths according to a distance between the display panel 300′ and the viewer to be turn ON parallel to the longitudinal direction of the cylindrical lenticular lens part 210′.

Further, the control unit 400′ may control the spaced distance in the width direction of the cylindrical lenticular lens part 210′of the point light sources 110′ turned ON in parallel in the longitudinal direction of the cylindrical lenticular lens part 210′ to correspond to the pitch of the cylindrical lenticular lens part 210′.

A fundamental principle of forming the line light sources 10a to 10c having different positions in the depth direction by the point light sources 110′ formed on the one surface of the light source substrate 100′ and the lenticular lens sheet 200′ disposed over the point light sources and spaced apart therefrom in the 3D image display apparatus using the line light source as described above will be described in detail below with reference to FIGS. 9 to 11.

That is, a configuration and operational principle of the point light sources 110′ for varying the optimal viewing distance (OVD) in the depth direction enables viewing of an optimal 3D image by setting an appropriate corresponding line light source set, even when a position of the viewer varies from the OVD, as long as a set of line light sources 10a to 10c having different distances spaced from the display panel 300′ on which the 3D image is displayed can be made.

If the point light sources 110′ having different positions in the depth direction among the point light sources 110′ arranged in the longitudinal direction of the cylindrical lenticular lens part 210′ are turned ON to form the line light sources 10a to 10c, the line light sources having different positions in the depth direction varied according to the OVD can be formed. Comparing FIG. 10 with FIG. 11, it will be appreciated that the positions of the line light sources 10a to 10c formed after passing the lenticular lens sheet 200′ can be varied according to the point light source sets having different positions in the depth direction.

As shown in FIG. 12, even when a distance from the display to the viewing position varies, a position of the line light sources capable of continuously providing a clean 3D image is represented by the following equations.

$$\begin{matrix}{L}_{s} = {NW}_{p} \frac{E}{E - {W}_{p}} & [ Equation 1 ] \\ d = \frac{{W}_{p} {L}_{0}}{E - {W}_{p}} & [ Equation 2 ]\end{matrix}$$

Here, Lₛ represents a distance between the line light sources, E represents an interval between the viewpoints, Wₚ represents a pixel size of an image display panel, Lₒ represents an OVD from the image display panel, d represents a distance between the display panel and the line light source, and N is a number of design viewpoints. Since the number of viewpoints shown in FIG. 12 is 2, N is 2. As can be seen from Equation 2, it will be appreciated that, as the distance Lₒ from the image display panel to the viewer increases, the distance d between the image display panel and the line light source needs to be increased.

A distance range between the line light source and the display is determined according to an allowable range of a viewing position of the viewer, and a position difference in the depth direction of the point light sources and a refractive index and a thickness of the lenticular lens shown in FIGS. 10 and 11 need to be appropriately selected according to the position range of the line light source.

When the line light sources 10a to 10c having different positions in the depth direction formed in accordance with the second exemplary embodiment of the present invention are applied, even if the position of the viewer with respect to the display panel 300′ varies, the positions of the formed line light sources 10a to 10c are varied such that the viewer can view the optimal 3D image.

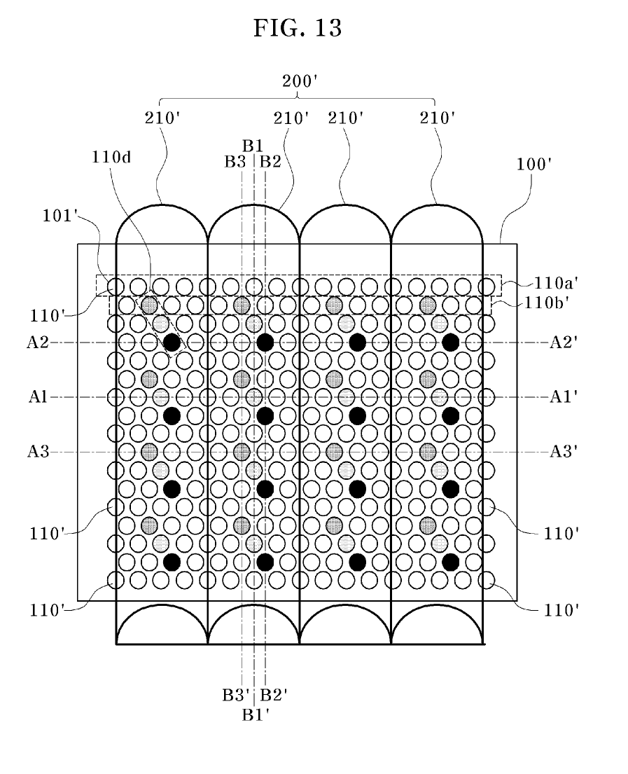

Meanwhile, even when the point light sources 110′ are disposed in different positions in the depth direction of FIG. 9 or FIG. 13 (described later), positions of the point light sources 110′ which are turned ON and have the same depth may be determined as different positions in a width direction of the cylindrical lenticular lens part 210′ to easily vary the position of the viewing zone formed in a horizontal direction.

Accordingly, when the line light sources shown in FIG. 9 or FIG. 13 (described later) are used, the apparatus can receive feedback of a conventional pupil tracking system to always display an optimal 3D image when the viewer moves in the horizontal direction or the depth direction.

### Third Embodiment

FIG. 13 is a planar concept view for explaining a 3D image display apparatus using a line light source in accordance with the third exemplary embodiment of the present invention. Since components of the third embodiment are similar to those of the second embodiment except that a disposition pattern of the point light sources is varied in comparison with the second embodiment of the present invention, like reference numerals designate like components of the second embodiment.

Meanwhile, for the convenience of description, differences between the second and third embodiments of the present invention will be described in detail. Configurations and operational principles of the same components will not be repeated.

Referring to FIG. 13, in the 3D image display apparatus using the line light source in accordance with the third exemplary embodiment of the present invention, the point light sources 110′ formed at one surface of the light source substrate 100′ are arranged such that at least one fourth point light source set 110d constituted of the plurality of point light sources 110′ disposed at predetermined intervals in an inclined manner from one side to the other side in the width direction of the cylindrical lenticular lens part 210′ is disposed at predetermined intervals in lengthwise and widthwise directions of the cylindrical lenticular lens part 210′. The plurality of point light sources 110′ provided in the fourth point light source set 110d are formed to different depths at one side surface of the light source substrate 100′ similar to the second embodiment of the present invention.

That is, the spaced distance between the adjacent point light sources 110′ necessary to form the line light sources 10a to 10c having different positions in the depth direction of FIG. 9 may be too far from each other. In this case, as shown in FIG. 13, the positions in the depth direction of the point light sources 110′ may be varied according to each row to reduce the interval between the point light sources 110′, which are turned ON at once, such that a uniform line light source can be formed.

### Fourth Embodiment

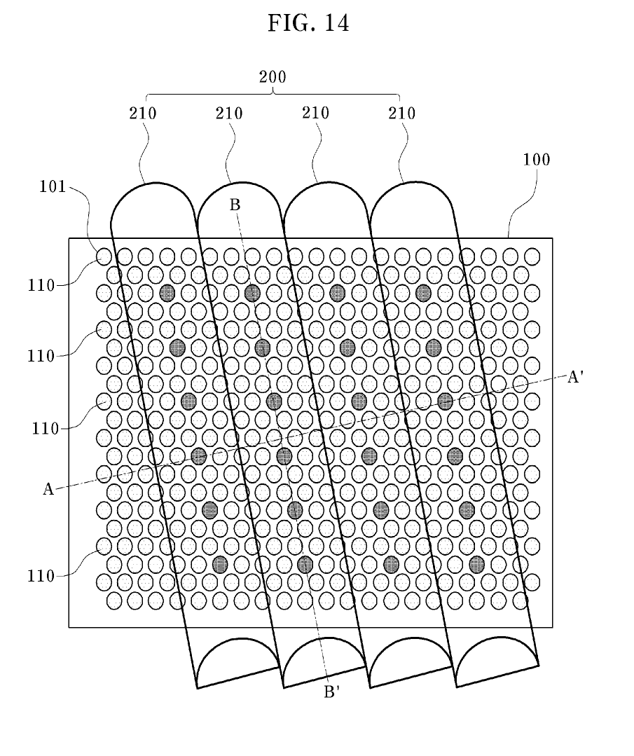

FIG. 14 is a planar concept view for explaining a 3D image display apparatus in accordance with a fourth exemplary embodiment of the present invention. Compared to the first embodiment, since the fourth embodiment is similar to the first embodiment except that only an arrangement direction of each cylindrical lenticular lens part 210 of the lenticular lens sheet 200 is varied, like reference numerals designate like components of the first embodiment.

Meanwhile, for the convenience of description, differences between the first and fourth embodiments of the present invention will be described in detail. Configurations and operational principles of the same components will not be repeated.

Referring to FIG. 14, in the 3D image display apparatus using the line light source in accordance with the fourth exemplary embodiment of the present invention, when the light source substrate 100 is seen from a plan view, the cylindrical lenticular lens parts 210 are disposed to be inclined toward one side of the light source substrate 100 at a certain angle.

The inclined arrangement of the cylindrical lenticular lens parts 210 is a method of forming an inclined line light source. When only a viewing zone in a horizontal direction is divided to implement a multi-viewpoint 3D image, only resolution in the horizontal direction may be degraded. When a pixel structure of the display configured to display an image is constituted of a disposition of sub pixels of R, G and B in a horizontal direction and a vertical line light source is used, color dispersion characteristics according to a viewing zone are represented. In order to solve these problems, the line light source needs to be formed inclined at a certain angle.

That is, in order to form the inclined line light source, the cylindrical lenticular lens part 210 of the lenticular lens sheet 200 is inclined from a vertical direction at a certain angle (the same angle as an inclined angle of the line light source to be formed), and only the point light sources 110 disposed at the same position as the cylindrical lenticular lens part 201 inclined at a certain angle need to be turned ON.

As shown in FIG. 14, since cross-sectional views of lines A-A′ and B-B′ of FIG. 14 are similar to lines A-A′ and B-B′ of FIG. 6, a line light source inclined from a vertical direction with respect to a display panel 300 spaced apart from the lenticular lens sheet 200 can be formed.

In addition, in ON control of the point light source set according to position movement of a viewer, when a vertical lenticular lens is used, only position movement in the vertical direction of the viewer does not need movement of a viewing zone, and thus, there is no need to vary the point light source set that is turned ON. However, if the inclined lenticular lens is used as in this embodiment, even when the viewer moves in the vertical direction, it may be necessary to vary the point light source set that is turned ON.

Hereinafter, a 3D image display method performed in the 3D image display apparatus as described above will be described.

First, the 3D image display apparatus measures a position of a viewer using a location tracking system. The location tracking system may be a location tracking system based on pupil tracking or face tracking of the viewer.

Then, a control unit of the 3D image display apparatus turns ON one arbitrary set of point light sources disposed in parallel in a longitudinal direction of the lenticular lens sheet and an adjacent set of point light sources spaced a first distance therefrom. That is, in order to allow the viewer to view a 3D image according to a position of the viewer, arbitrary point light sources at appropriate positions are turned ON to form line light sources spaced a predetermined interval from the lenticular lens sheet. The first distance may correspond to a pitch of the lenticular lens sheet.

Here, when the viewer varies a viewing position from the display panel, according to information on a position of the viewer measured by the location tracking system, the control unit can adjust positions of the one arbitrary set of point light sources and the adjacent set of point light sources that are turned ON. As a result, the 3D image can be displayed without distortion even when the viewing position of the viewer varies. In particular, when a distance between the viewer and the display panel varies, according to information on the position of the viewer measured by the location tracking system, the control unit can turn ON one set constituted of point light sources in a first depth direction among the point light sources having different distances in the depth direction and an adjacent set of point light sources in the first depth direction spaced a first distance therefrom. Accordingly, it is possible to see the 3D image without distortion even when the viewing position of the viewer varies.

As can be seen from the foregoing, in a 3D image display apparatus in accordance with an exemplary embodiment of the present invention, an ON operation of a plurality of point light sources is controlled to generate a plurality of line light sources spaced apart from each other using the plurality of point light sources and a lenticular lens sheet such that the viewer can view a 3D image without special 3D glasses.

Also, in an exemplary embodiment of the present invention, even when the position of the viewer from the display panel varies, an ON operation of the point light sources is controlled such that the viewer can move and view an optimal 3D image without special glasses.

Further, in an exemplary embodiment of the present invention, as a separate location tracking system is provided, even when the viewer viewing a 3D image from the display panel moves, the viewer can view a smooth 3D image.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. A three-dimensional (3D) image display apparatus, comprising:
a light source substrate formed by disposing a plurality of point light sources on a plane;
a lenticular lens sheet spaced a predetermined interval from the light source substrate;
a control unit configured to control the plurality of point light sources of the light source substrate to form line light sources spaced a predetermined interval from the lenticular lens sheet; and
a display panel spaced a predetermined interval from the line light sources formed by the control unit.

2. The 3D image display apparatus according to claim 1, wherein the plurality of point light sources are formed of optical fibers.

3. The 3D image display apparatus according to claim 1, wherein the plurality of point light sources are formed of liquid crystal displays (LCDs) or light emitting diodes (LEDs).

4. The 3D image display apparatus according to claim 1, wherein one arbitrary set of point light sources disposed in parallel in a longitudinal direction of the lenticular lens sheet and an adjacent set of point light sources spaced a first distance from the one set of point light sources, among the plurality of point light sources, are turned ON by the control unit.

5. The 3D image display apparatus according to claim 4, wherein the first distance corresponds to a pitch of the lenticular lens sheet.

6. The 3D image display apparatus according to claim 2, wherein the optical fibers forming the point light sources are constituted of two or more kinds of point light source sets having different distances in a depth direction of the lenticular lens sheets spaced apart from each other.

7. The 3D image display apparatus according to claim 3, wherein the LCDs or LEDs are formed of stack-type panels.

8. The 3D image display apparatus according to claim 4, further comprising a location tracking system for the viewer,
wherein the control unit receives information on a position of the viewer measured by the location tracking system and adjusts positions of the one arbitrary set of point light sources and positions of the adjacent set of point light sources such that a 3D image can be viewed without distortion even when the viewing position of the viewer varies.

9. The 3D image display apparatus according to claim 8, wherein the location tracking system is a location tracking system based on pupil tracking or face tracking of the viewer.

10. The 3D image display apparatus according to claim 1, wherein a formation direction of a lenticular shape of the lenticular lens sheet is inclined from a vertical direction at a certain angle.

11. The 3D image display apparatus according to claim 4, wherein a formation direction of a lenticular shape of the lenticular lens sheet is inclined from a vertical direction at a certain angle.

12. The 3D image display apparatus according to claim 6, wherein, as a distance between a position of the viewer and the 3D image display apparatus varies, one set of point light sources having a first depth direction among the point light sources having different distances in the depth direction and the adjacent set of point light sources in the first depth direction spaced a first distance therefrom are turned ON.

13. The 3D image display apparatus according to claim 12, wherein the first distance corresponds to a pitch of the lenticular lens sheet.

14. A three-dimensional (3D) image display method performed in a 3D image display apparatus including a light source substrate formed by disposing a plurality of point light sources on a plane, a lenticular lens sheet spaced a predetermined interval from the light source substrate, a display panel spaced a predetermined interval from line light sources, and a location tracking system for a viewer, the method comprising:
measuring a position of the viewer by the position tracking system; and
turning ON one arbitrary set of point light sources disposed in parallel in a longitudinal direction of the lenticular lens sheet and an adjacent set of point light sources spaced a first distance from the one set of point light sources according to position information on the viewer to form line light sources spaced a predetermined interval from the lenticular lens sheet.

15. The 3D image display method according to claim 14, wherein, when the viewer varies the viewing position from the display panel, positions of the one arbitrary set of point light sources and positions of the adjacent set of point light sources, which are turned ON, are adjusted according to the position information on the viewer such that a 3D image is viewed without distortion even when the viewing position of the viewer varies.

16. The 3D image display method according to claim 15, wherein, when a distance between the viewer and the display panel varies, one set of point light sources having a first depth direction among the point light sources having different distances in the depth direction and an adjacent set of point light sources in the first depth direction spaced a first distance therefrom are turned ON according to the position information on the viewer so that the 3D image is viewed without distortion even when the viewing position of the viewer varies.

17. The 3D image display method according to claim 14, wherein the first distance corresponds to a pitch of the lenticular lens sheet.

18. The 3D image display method according to claim 14, wherein the location tracking system is a location tracking system based on pupil tracking or face tracking of the viewer.
